(19) United States
(12) Patent Application Publication
(10) Pub. No.: US 2004/0126011 A1
(43) Pub. Date: Jul. 1, 2004

(54) IMAGE SCANNING METHOD

(76) Inventor: Chung-Wei Cheng, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/248,207

(22) Filed: Dec. 27, 2002

(51) Int. Cl. G06T 7/00; H04N 1/48; H04N 1/64

(52) U.S. Cl. 382/164; 358/505; 358/524; 358/530; 382/319

(57) ABSTRACT

An image scanning method, applied to a document, performs a preliminary scanning operation to distinguish the document into areas uniformly containing a same color level and scanned areas containing different color levels. An image scanning sequence is subsequently performed, during which an area of the document to be scanned is skipped if it has been determined as an area uniformly having a same color level. A color code value corresponding to the uniform color level of this area is consequently stored in a corresponding memory zone. The above image scanning sequence is executed until the scanning of the document is completed.

### BACKGROUND OF INVENTION

1. Field of the Invention

The invention relates generally to an image scanning method and, more particularly, to an image scanning method that has a faster scanning speed.

2. Description of the Related Art

In the operation of a scanning apparatus known in the art, a light is usually projected on the document to be scanned, which produces an image light that travels back to form an image on an array of image sensors such as charge coupled devices (CCD). The image sensors convert the photons of the image light to electrical signals that then are converted to digital data to form a digital image. A criterion of quality of the image is usually the image resolution, expressed in dots per inch of the image. The obtention of an image with high resolution requires a longer scanning time and more memory capacity.

The CCD image sensor per se is incapable of distinguishing color features. Color filters, usually red, green and blue filters, therefore are associated with the CCD image sensors in order to obtain color information of the scanned image. One method known in the art is to perform three scanning operations to successively obtain the three colors by means of the color filters, which increases the scanning time. Another method known in the art, by means of a specific color filter structure, allows to perform a single scanning operation to obtain the color information. However, this type of scanning apparatus is more expensive to produce.

As described above, the image resolution and the scanning time therefore greatly affect the processing speed of the scanning apparatus. This processing speed of the scanning apparatus may be also affected by other factors such as the speed of the transmission interface and the processing speed of the computer. Currently, there is an increasing demand for a scanning apparatus with a generally faster processing speed, and the performance of the conventional scanning apparatus fails to meet this demand.

### SUMMARY OF INVENTION

An aspect of the invention is therefore to provide an image scanning method that allows to scan an image with a faster scanning speed.

To accomplish the above and other objectives, an image scanning method of the invention, applied to a document, performs a preliminary scanning operation to distinguish the document into scanned areas uniformly containing a same color level and scanned areas containing different color levels. An image scanning sequence is subsequently performed, during which an area of the document to be scanned is skipped if it has been determined as an area uniformly having a same color level. A color code value corresponding to the uniform color level of this area is consequently stored in a corresponding memory zone. The above image scanning sequence is executed until the scanning of the document is completed.

According to an embodiment of the invention, the storage of the color code value is performed by means of an image processing program. The preliminary scanning operation further enables to collect and evaluate an image information, including the color levels, the scanning areas, the color distribution, and the image inclination angle.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic view illustrating the operation of an image scanning method vis-à-vis a document to be scanned and a memory mapping, according to an embodiment of the invention; and

FIG. 2 is a flow chart schematically illustrating an image scanning method according to an embodiment of the invention.

### DETAILED DESCRIPTION

The following detailed description of the embodiments and examples of the present invention with reference to the accompanying drawings is only illustrative and not limiting. Furthermore, wherever possible in the description, the same reference symbols will refer to similar elements and parts unless otherwise illustrated in the drawings.

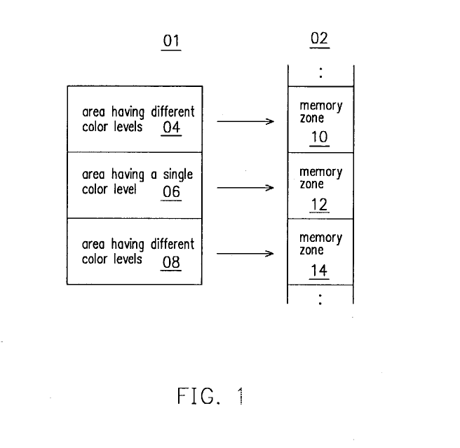

FIG. 1 is a schematic diagram that illustrates the operation of an image scanning method according to an embodiment of the invention. In FIG. 1, reference numeral 01 designates a scanned document, and reference numerals 04, 06, 08 describe an example of area configuration of the scanned document. More particularly, reference numeral 04 designates an area having different color levels, reference numeral 06 designates an area uniformly having a same single color level, and reference numeral 08 designates an area having different color levels. Furthermore, reference numeral 02 represents an example of memory mapping corresponding to the area configuration of the scanned document sheet, and reference numerals 10, 12, 14 designate memory zones that store the scanned data corresponding to the area configuration of the scanned document sheet.

“Area having a same single color level” means that the area uniformly has a same single color level, such as pure white, pure black, pure red, etc. “Area having different color levels” means that the area contains a plurality of different color levels such as multi-colored pictures, multi-colored characters, etc.

According to the invention, the scanning of the document 01 comprises a preliminary scanning operation during which various image information related to the document 01 are evaluated and collected. The image information includes the color levels, the scanning areas, the color distribution, the image inclination angle, etc. As a result of this preliminary scanning operation, it is determined whether the areas 04, 06, 08 respectively have a single color level or a plurality of different color levels. In the illustrated example of FIG. 1, the area 04 has different color levels, the area 06 uniformly has a same single color level, and the area 08 has different color levels. The above information is stored in, for example, the memory 02. In particular, an area that uniformly has a single color level (such as the area 06) is defined as a skipped scanning area.

After the preliminary scanning operation has been achieved, an image scanning sequence is applied to the document 01. In this image scanning sequence, the previously distinguished areas of the document are checked to determine whether one. currently processed area has to be skipped or scanned depending on whether it uniformly has a single color level or has different color levels.

In the illustrated example, this sequence starts with checking whether the area 04 is either uniformly of a same single color level or of different color levels. Since the area 04 has been previously detected as an area of different color levels in the preliminary scanning operation, the area 04 therefore is scanned and the color level data are stored in the corresponding memory zone 10. Subsequently, it is checked whether the scanning of the document 01 is completed. Since the area 06 remains, the image scanning sequence therefore continues with checking whether the area 06 is of a same single color level or of different color levels. Since the area 06 has been previously determined as an area uniformly of a same single color level, this area 06 is therefore skipped and a predetermined color code value corresponding to the color level of the area 06 is written in the corresponding memory zone 12. Subsequently, it is checked whether the scanning of the document 01 is completed. Since the area 08 remains, the image scanning sequence therefore continues with checking whether the area 08 contains a same single color level or different color levels. Since the area 08 has been previously determined as an area containing different color levels, the area 08 therefore is scanned and the obtained color level data are stored in the corresponding memory zone 14. Subsequently, since all the areas of the document have been scanned, the scanning of the document 01 is therefore completed.

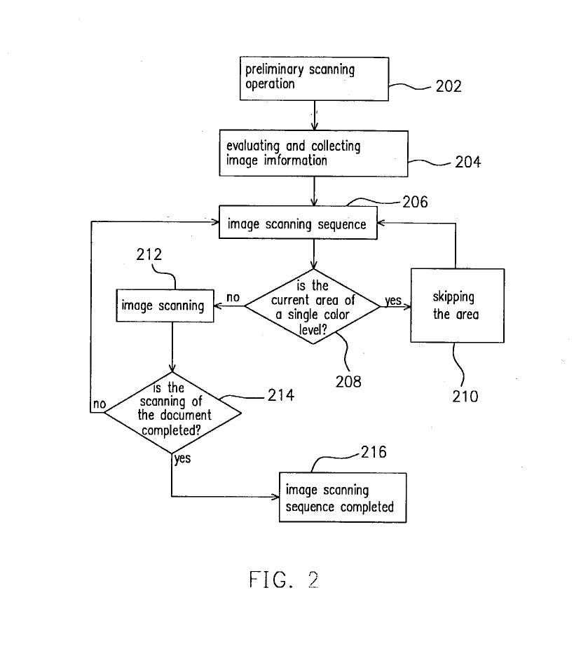

FIG. 2 is a flow chart that generally describes the above image scanning method according to an embodiment of the invention. At step 202, the method of the invention starts with a preliminary scanning operation. At step 204, the information obtained from the preliminary scanning operation of step 202 is evaluated and collected. In particular, scanned areas of the pre-scanned document are distinguished into areas uniformly containing a same color and areas containing a plurality of colors. At step 206, an image scanning sequence then is performed. This image scanning sequence starts with checking whether the current area to be scanned uniformly contains a single color level (step 208). If yes, the current area is skipped, and via an image scanning program (for example a driving application), a color code value corresponding to the color level (for example “00H” for pure white) is written in the corresponding memory zone (step 210); then return to step 206. If the current area does not have a single color level, the current area is effectively scanned, and the color level data are stored in the corresponding memory zone (step 212). At the subsequent step 214, it is checked whether the scanning of the document is completed; if no, then return to step 206; otherwise, the image scanning sequence ends (step 216).

As described above, the image scanning method of the invention, by skipping areas uniformly having single color levels, therefore increases the scanning speed and favorably reduces the time needed to complete the scanning of a document.

It should be apparent to those skilled in the art that other structures that are obtained from various modifications and variations of different parts of the above-described structures of the invention would be possible without departing from the scope and spirit of the invention as illustrated herein. Therefore, the above description of embodiments and examples only illustrates specific ways of making and performing the invention that, consequently, should cover variations and modifications thereof, provided they fall within the inventive concepts as defined in the following claims.

1. An image scanning method, being applied to a document, the image scanning method being characterized in that:
when the image of the document is being scanned, if an area of the document uniformly contains a single color level, the scanning of the area with the single color level is skipped and a color code value corresponding to the single color level is stored.

2. The method of claim 1, wherein the storage of the color code value corresponding to the single color level is performed via an image processing program.

3. The method of claim 2, wherein the image processing program is a driving application.

4. The method of claim 1, wherein before the document is scanned, a preliminary scanning operation is performed to collect and evaluate a plurality of information related to the image of the document, thereby the document is distinguished into a plurality of scanning areas that are either areas uniformly having a same color level or areas having different color levels.

5. The method of claim 4, wherein the collected information includes a color type.

6. The method of claim 5, wherein the collected information includes a scanned area.

7. The method of claim 6, wherein the collected information includes a color distribution.

8. The method of claim 7, wherein the collected information includes an image inclination angle.

9. An image scanning method, applied to a document, the image scanning method comprising:
performing a preliminary scanning operation;
evaluating and collecting an image information obtained from the preliminary scanning operation, wherein the obtained information allows to distinguish the document into a plurality of scanning areas that are either areas uniformly having a single color level or areas having different color levels;
performing an image scanning sequence, during which if one current area of the document to be scanned is an area uniformly having a single color level, the current area is skipped and a color code value corresponding to the single color level is stored.

10. The method of claim 9, wherein the storage of the color code value corresponding to the single color level is performed via an image processing program.

11. The method of claim 10, wherein the image processing program is a driving application.

12. The method of claim 9, wherein the image information obtained from the preliminary scanning operation includes a color type.

13. The method of claim 12, wherein the image information obtained from the preliminary scanning operation further includes a scanning area.

14. The method of claim 13, wherein the image information obtained from the preliminary scanning operation further includes a color distribution.

15. The method of claim 14, wherein the image information obtained from the preliminary scanning operation further includes an image inclination angle.

16. The method of claim 9, wherein if the current area of the document to be scanned is an area having different color levels, the current area with different color levels is scanned.
